(19) United States
(12) Patent Application Publication
(10) Pub. No.: US 2026/0314793 A1
(43) Pub. Date: Oct. 15, 2026

(54) ATTACHMENT FOR HAIR CARE APPLIANCE

(71) Applicant: SharkNinja Operating LLC, Needham, MA (US)

(72) Inventors: Kyle Marciniak, Brookline, MA (US); Bryan Nelson, Needham, MA (US)

(21) Appl. No.: 19/175,173

(22) Filed: Apr. 10, 2025

(51) Int. Cl. A45D 20/12

(52) U.S. Cl. CPC A45D 20/122

(57) ABSTRACT

An attachment for a hair care appliance is provided and can include an inlet, an outlet, an airflow path extending therebetween, and a surface adjacent to the airflow path having a plurality of openings. Air flowing along the airflow path creates a suction force at the surface to draw ambient air through the plurality of openings that draw hair towards the surface. A hair care appliance is also provided and can include an air inlet, an air outlet, a lumen extending between the air inlet and the air outlet, a porous surface extending adjacent to at least a portion of the lumen, and a fan assembly configured to generate an airflow path through the lumen between the inlet and the outlet. Ambient air is drawn into the lumen through the porous surface to cause hair adjacent to the surface to be drawn in against the surface.

### FIELD

An attachment for use with a hair care appliance is provided.

### BACKGROUND

Hair care appliances are devices used for drying and styling of hair. Hair care appliances can include a variety of components operable to provide a fluid flow via a fluid flow path extending through the device. The fluid flow path receives ambient air at an inlet of the hair care appliance and directs the ambient air through the hair care appliance via a motor and fan assembly. The fluid flow path is directed across a heating assembly to generate heated air at an outlet of the hair care appliance. Air is expelled from the hair care appliance via an outlet arranged to enable a user to dry or style hair.

One or more attachments are often used with the hair care appliance depending on the user’s hair styling or treatment needs. Attachments can be coupled to the outlet of the hair care appliance and can be designed to perform specific functions on the hair.

### SUMMARY

In general, an attachment configured for use with a hair care device, such as a hair dryer for use in drying and/or styling hair, is provided. In one aspect, an attachment for a hair care appliance is provided and can include an inlet, an outlet, an airflow path extending therebetween. The attachment also can include a surface adjacent to the airflow path having a plurality of openings. The attachment can be configured such that air flowing along the airflow path creates a suction force at the surface to draw ambient air through the plurality of openings that draw hair towards the surface.

In one embodiment, the surface can be planar. In another embodiment, the plurality of openings can extend through the surface at an angle relative to a longitudinal axis of the airflow path exiting the outlet. In one embodiment, the plurality of openings can include a first plurality of inlet channels and a second plurality of inlet channels. The first and second plurality of inlet channels can be fluidically oriented transversely to a longitudinal axis of the airflow path exiting the outlet. In another embodiment, the first and second plurality of inlet channels can be fluidically coupled to one another via a conduit oriented parallel to the longitudinal axis of the airflow path exiting the outlet. In one embodiment, the first and second plurality of inlet channels can be offset from one another relative to the longitudinal axis of the airflow path exiting the outlet.

In another embodiment, the surface can be positioned transversely to an axis of the airflow path entering the inlet. In one embodiment, the surface can include a first surface spaced apart from a second surface such that the airflow path flows between the first surface and the second surface prior to exiting the outlet. In another embodiment, the first surface and the second surface can be planar surfaces. In one embodiment, a distal end of the second surface can extend beyond a distal end of the first surface relative to the longitudinal axis of the airflow path exiting the outlet.

In another embodiment, the attachment can include a nozzle having a substantially cylindrical first portion defining the inlet therein. The nozzle can be configured to mate to a hair care appliance. In one embodiment, the attachment can include a first cover and a second cover coupled to the first cover and enclosing the nozzle therein. At least one of the first cover and the second cover can include at least one second inlet open to an ambient environment surrounding the attachment. In another embodiment, the attachment can be configured such that suction force is generated based on a static pressure of the airflow flowing along the airflow path adjacent to the surface being lower than a static pressure of an airflow received at the inlet.

In another aspect, a hair care appliance is provided and in one embodiment, the hair care appliance can include an air inlet, an air outlet, a lumen extending between the air inlet and the air outlet, a porous surface extending adjacent to at least a portion of the lumen, and a fan assembly configured to generate an airflow path through the lumen between the inlet and the outlet such that ambient air is drawn into the lumen through the porous surface to cause hair adjacent to the surface to be drawn in against the surface.

In another embodiment, the porous surface can include a plurality of pores oriented at an angle relative to a longitudinal axis of the airflow path exiting the air outlet. In one embodiment, the porous surface can include a first plurality of pores coupled to a second plurality of pores via a common conduit extending within the porous surface parallel to a longitudinal axis of the airflow path exiting the air outlet. In another embodiment, the first plurality of pores can be offset from the second plurality of pores relative to the longitudinal axis of the airflow path exiting the air outlet.

In one embodiment, the porous surface can be spaced apart from a second surface opposite the porous surface and defining the lumen therebetween. In another embodiment, the hair care appliance can include at least one ridge extending between the porous surface and second surface and defining a height of the air outlet. In one embodiment, the hair care appliance can include opposing end walls extending from the second wall toward the first wall. The opposing end walls can include a groove extending longitudinally there along and configured to receive a protrusion extending longitudinally along opposing ends of the first wall. In another embodiment, the lumen can include at least two lumen portions dividing the airflow path through the lumen. In another embodiment, the fan assembly can be configured to generate a static pressure in the airflow path through the lumen that is higher than a static pressure of an airflow path entering the air inlet.

### DESCRIPTION OF DRAWINGS

These and other features will be more readily understood from the following detailed description taken in conjunction with the accompanying drawings, in which:

FIG. 1 is a front-side perspective view of one exemplary embodiment of a polishing attachment configured for use with a hair care appliance;

FIG. 2 is a rear-side perspective view of the polishing attachment of FIG. 1;

FIG. 3 is a bottom perspective view of the polishing attachment of FIG. 1;

FIG. 4A is a front perspective view of a porous surface of the polishing attachment of FIG. 1;

FIG. 4B is a rear perspective view of a porous surface of the polishing attachment of FIG. 1;

FIG. 5 is a cross-sectional view of the porous surface of FIGS. 4A and 4B;

FIG. 6 is a cross-sectional view of the polishing attachment of FIG. 1 illustrating air flow therein;

FIG. 7 is an image illustrating a side view of the polishing attachment of FIG. 1 and computational fluid dynamic (CFD) data illustrating a velocity of a fluid exiting the outlet of the attachment and a fluid suctioned toward the porous surface;

FIG. 8 is an image illustrating a front view of the polishing attachment of FIG. 1 and CFD data illustrating a velocity of a fluid exiting the outlet of the attachment;

FIG. 9 is an image illustrating a front view of the polishing attachment of FIG. 1 and CFD data illustrating a static pressure of a fluid exiting the outlet of the attachment;

FIG. 10 is a bottom perspective view of another embodiment of a polishing attachment configured for use with a hair care appliance;

FIG. 11A is a is a front perspective view of a porous surface of the polishing attachment of FIG. 10;

FIG. 11B is a rear perspective view of a porous surface of the polishing attachment of FIG. 10;

FIG. 12A is a cross-sectional view of the porous surface of FIGS. 11A and 11B illustrating a plurality of inlet channels configured within the porous surface;

FIG. 12B is a cross-sectional view of the porous surface of FIGS. 11A and 11B illustrating a plurality of conduits fluidically coupling the inlet channels configured within the porous surface;

FIG. 13 is a cross-sectional view of the polishing attachment of FIG. 10 illustrating air flow therein;

FIG. 14 is an image illustrating a side view of the polishing attachment of FIG. 10 and CFD data illustrating a velocity of a fluid exiting the outlet of the attachment and a fluid suctioned toward the porous surface;

FIG. 15 is an image illustrating a front view of the polishing attachment of FIG. 10 and CFD data illustrating a velocity of a fluid exiting the outlet of the attachment;

FIG. 16 is an image illustrating a front view of the polishing attachment of FIG. 10 and CFD data illustrating a static pressure of a fluid exiting the outlet of the attachment;

FIG. 17 is a top-side perspective view of an attachment mating assembly of a hair care appliance configured to couple with an appliance mating mechanism of the polishing attachment of FIGS. 1 and 10;

FIG. 18A is a side view of the attachment mating assembly of FIG. 17 coupled with the appliance mating mechanism of the polishing attachment of FIGS. 1 and 10 with a cover of the hair care appliance removed; and

FIG. 18B is a cross-sectional view of a portion of the attachment mating assembly of FIG. 17 coupled with the appliance mating mechanism of the polishing attachment of FIGS. 1 and 10 with a portion of the cover of the hair care appliance removed.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Various exemplary attachments or accessories for use with a hair care appliance, such as a hair dryer, are provided herein. In one embodiment, an attachment in the form of a hair polishing accessory is provided. The polishing attachment can be configured to efficiently engage with hair to smooth an uneven texture of hair, reduce hair frizz, and/or improve hair shine. The polishing attachment can include one or more features to aid in polishing. For example, the polishing attachment can include a porous surface through which a suction force can be formed to entrain ambient air toward the porous surface so that individual hairs are drawn toward and into contact the porous surface. The hair may also be drawn into contact with the high-velocity fluid flow that is provided via an outlet of the attachment. The suction force can be generated by a venturi effect that is created along the fluid flow path extending through the attachment. The venturi effect can create a low-pressure, high-velocity fluid flow adjacent to the surface such that the suction force draws ambient air and individual hairs toward the surface for styling treatment. In contrast, the fluid flow entering the air inlet of the attachment (e.g., the fluid flow received from an outlet end of a hair care appliance to which the attachment can be coupled) can flow into the attachment with high-pressure, low-velocity characteristics. Advantageously, these features can provide an enhanced styling experience, particularly for smoothing, straightening, reducing frizz, and/or improving the shine of a user’s hair compared to other attachments for a hair care appliance.

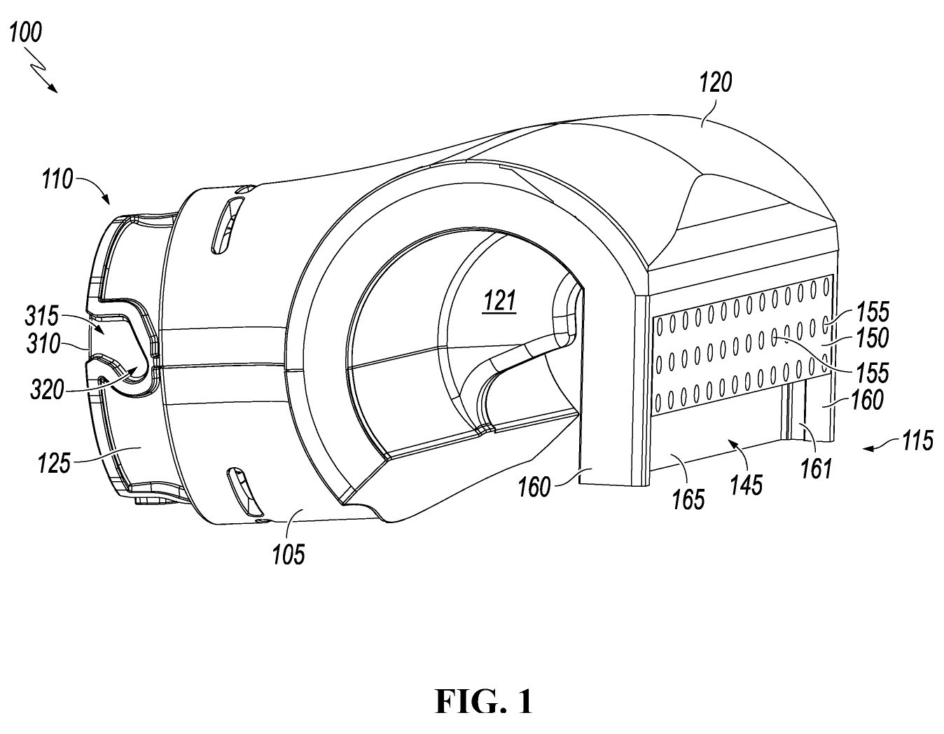

FIGS. 1-9 illustrate one exemplary embodiment of an attachment 100. In this embodiment, the attachment 100 is in the form of a polishing attachment, however a person skilled in the art will appreciate that the features shown in the figures can be utilized in various other types of attachments, such as straighteners, or curlers. Further, the features can be directly incorporated into a hair styling device and do not need to be a separate attachment. As shown in FIG. 1, the attachment 100 is substantially “T”-shape and include a substantially cylindrically-shaped proximal end 110 and a substantially hemi-cylindrically-shaped or C-shaped distal end 115 that is opposite the proximal end 110. A first body portion 105 can have a substantially cylindrical shape at the proximal end 110 and a second body portion 120 can have a substantially hemi-cylindrically-shape or C-shape at the distal end 115. The second body portion 120 can be oriented transversely to the first body portion 105. The first and second body portions 105, 120 together define an airflow path for receiving a primary airflow F from a hair care appliance and delivering air to an outlet 145 at the distal end 115. As discussed further below, the second body portion 120 includes a porous surface through which a suction force is created to draw hair against the surface for smoothing and polishing the hair. As further discussed below, the first and second body portions 105, 120 include a second airflow FA therethrough for receiving secondary air, which combines with the primary airflow F and is delivered to the outlet 145.

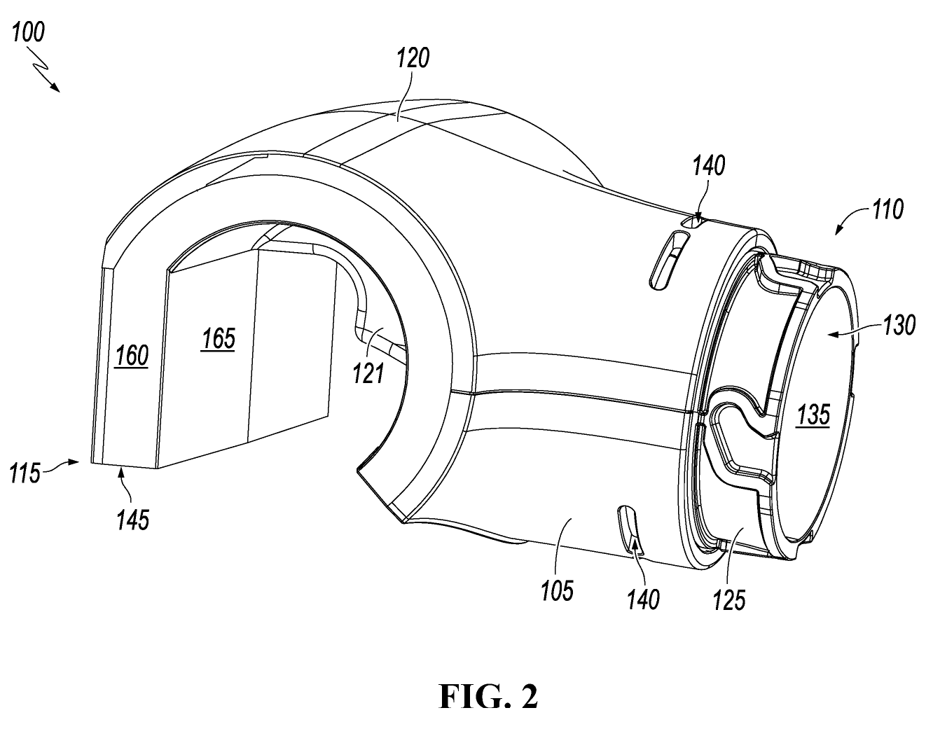

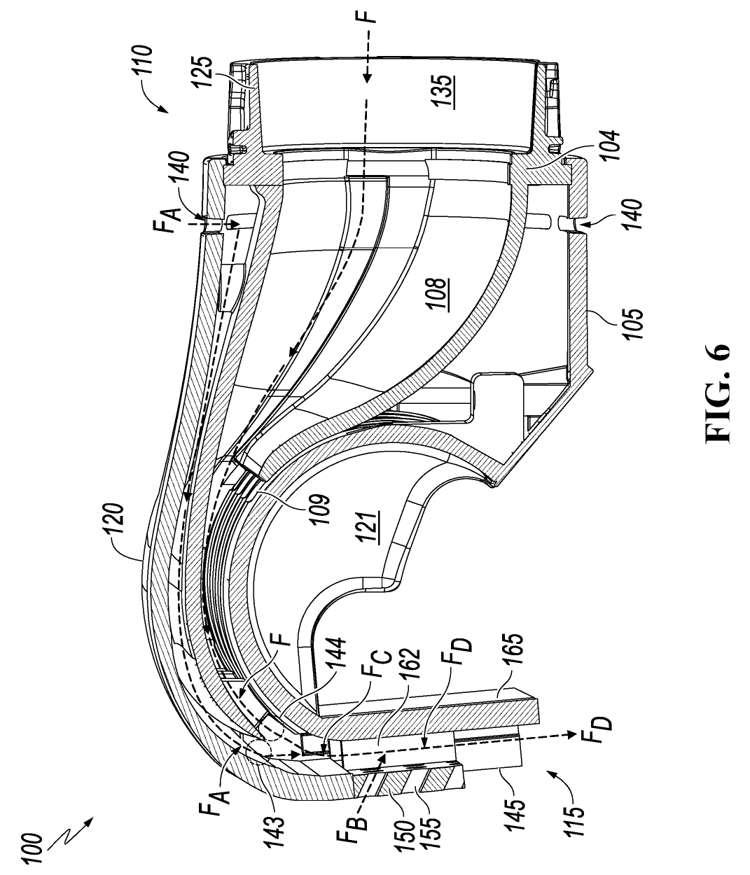

The first body portion 105 of the attachment 100 can have a variety of configurations, but in general it is configured to mate to a hair care appliance, and can define an airflow pathway therein for receiving airflow F from the hair care appliance and for delivering it to the hemi-cylindrically-shaped or C-shaped second body portion 120. As shown, the proximal end 110 includes an appliance mating mechanism 125 configured to mate the attachment 100 with a hair care appliance, such as a hair dryer. The appliance mating mechanism 125 can utilize various mating techniques, such as a twist-lock, magnets, a pressure-fit, or any other mating technique to facilitate attachment to a hair care appliance. The appliance mating mechanism 125 can include an opening 130 at the proximal end 110 defining a first air inlet 135, as shown in FIG. 2. The first air inlet 135 can receive air from the hair care appliance when the attachment 100 is coupled to the hair care appliance via the appliance mating mechanism 125. The air inlet 135 can be fluidically coupled to a nozzle 104 as shown in FIG. 6 positioned within a cavity between the first body portion 105 and the second body portion 120. The nozzle 104 can extend from the proximal end 110 and into the second body portion 120 toward the distal end 115, and it can guide an airflow received from the hair care appliance toward an air outlet 145 at the distal end 115 of the attachment 100. In some embodiments, the second body portion 120 can include vanes 109 downstream of the nozzle 104 to aid in guiding the airflow. Further, in some embodiments, the vanes 109 can positioned in between or extend from portions of a heat-retention element, such as a thermally conductive metal plate positioned in the first body portion 105 or the second body portion 120. In some embodiments, the vanes 109 can additionally or alternatively be configured in the first body portion 105, such as on an inner surface of the nozzle 104 adjacent to the second body portion 120.

As further shown in FIG. 6, the nozzle can 104 can be spaced from an outer-most wall of the attachment 100 to define a primary airflow F within the attachment. The first body portion 105 can include one or more second air inlets 140 provided thereon and positioned at various locations there around. The air inlets 140 can extend into a secondary airflow FA and can be fluidically coupled with the primary airflow path such that a combined airflow FC is delivered toward the air outlet 145 at the distal end 115. In some embodiments, the air inlets 140 can be slot shaped, as shown. In some embodiments, the air inlets 140 can have other shapes besides slots, such as circles, ovals, or the like. In some embodiments, the configuration of the air inlets 140 in the first body portion 105 can be configured such that the airflow FA can cool the outer surfaces of the first body portion 105 and the second body portion 120.

Further details on the cylindrically-shaped configuration of the first body portion 105 and the hemi-cylindrically-shaped configuration of the second body portion 120 can be found in U.S. Patent Appl. No. 18/174,769 filed on Feb. 27, 2023, which is hereby incorporated by reference in its entirety.

As indicated above, the second body portion 120 is substantially hemi-cylindrically-shaped or C-shaped and is configured to receive air from the first body portion 105. In general, the second body portion 120 includes walls 150 and 165 that are spaced a distance apart from one another to define the airflow path therein. The walls 150 and 165 can extend from a first curved portion of the hemi-cylindrically-shaped second body portion 120 and can then become planar along a second planar portion extending toward the outlet 145. As shown in FIGS. 1-3, the second planar portion includes two planar walls 150, 165 that are spaced a distance apart from one another. A sidewall 160 extends between the two planar walls 150, 165 to form an enclosed area between the walls 150, 165. The walls 150, 160, and 165 together define the air outlet 145 at the distal end 115. As further shown, wall 150 can be porous with multiple openings therein configured to draw a third airflow FB toward the wall 150 as shown in FIG. 6 and into combination with the combined airflow FC created by the combination of the primary airflow F received via the air inlet 135 and the secondary airflow FA received via the air inlets 140. Once the third airflow FB is combined with the combined airflow FC, a resultant airflow FD passes between the walls 150 and 165 of the air outlet 145. In some embodiments, wall 150 can terminate a distance upstream of the air outlet 145, and thus walls 160 and 165 can extend past wall 150, such that a length of walls 160, 165 is greater than a length of wall 150.

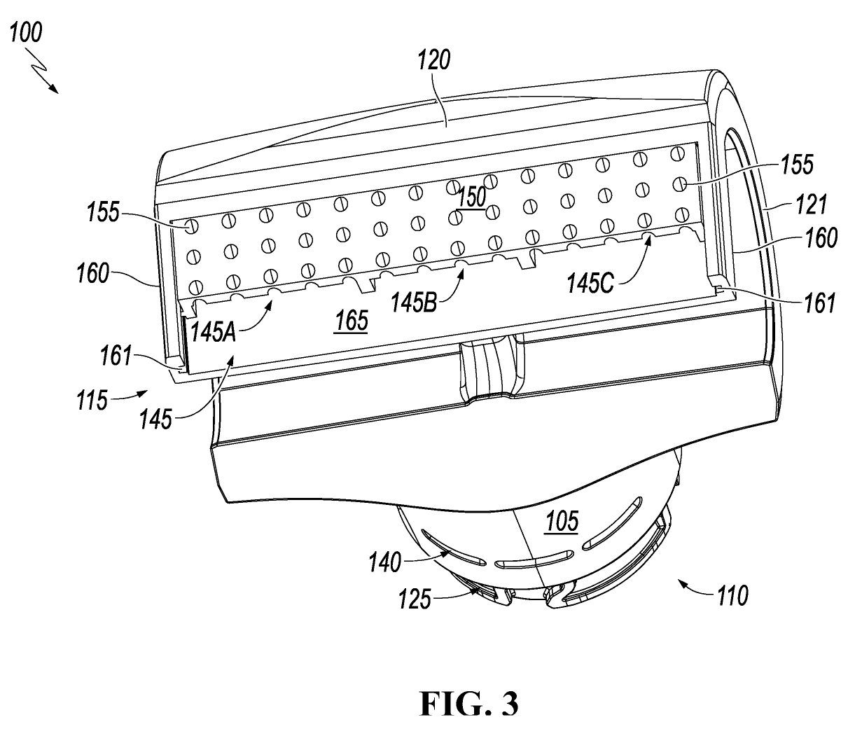

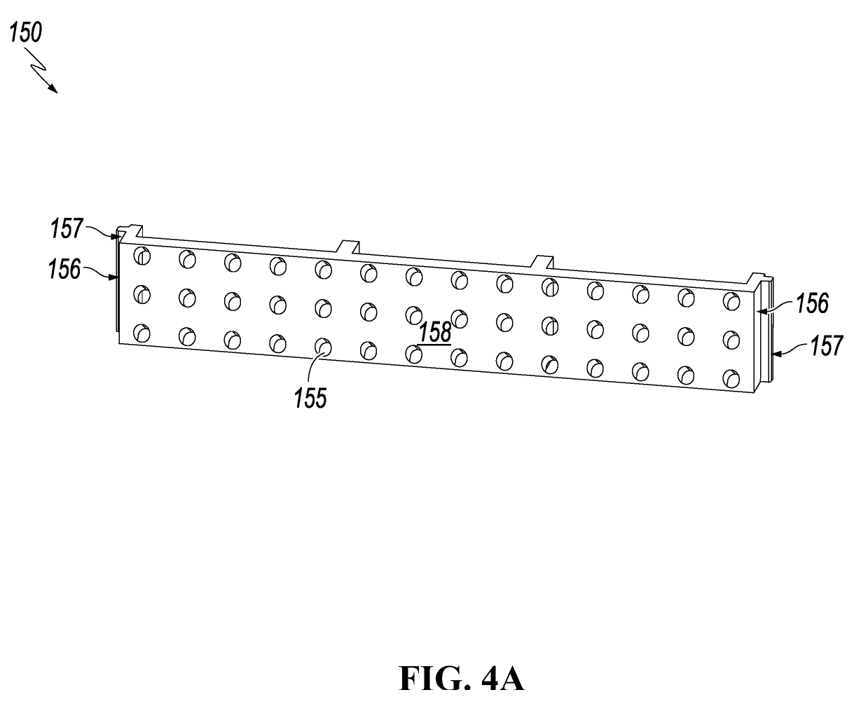

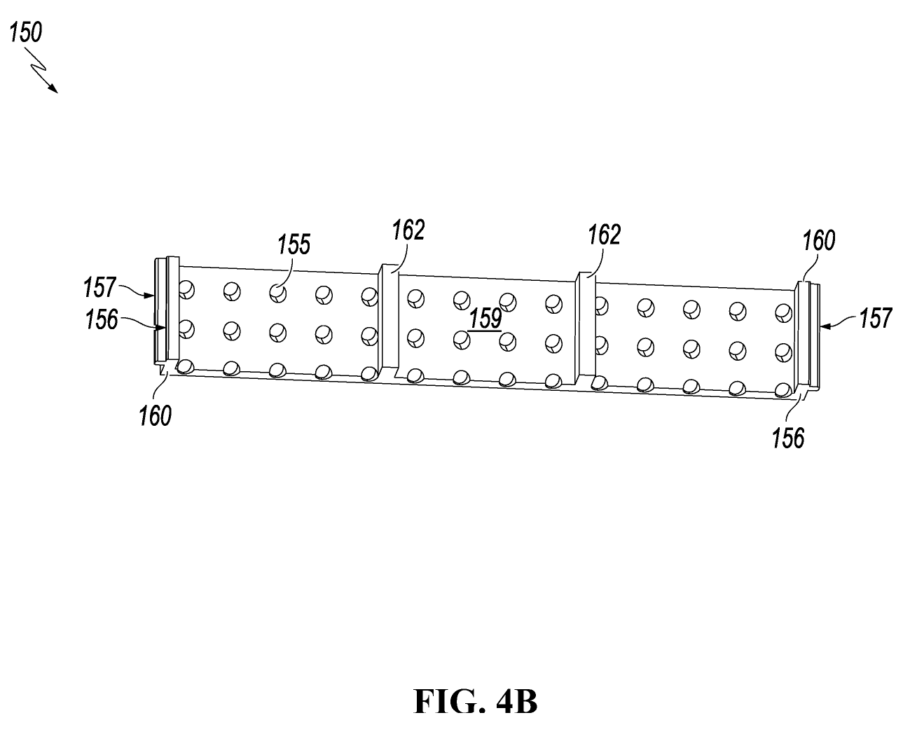

In some embodiments, wall 150 can be coupled to the side walls 160 via an attachment mechanism, such as a snap-fit, friction-fit, or the like. As shown in FIGS. 1 and 3, the attachment mechanism includes a groove 161 extending along the side walls 160. The groove 161 can be configured to receive a protrusion 157, shown in FIGS. 4A -5, extending along the side walls 156 that protrude from the wall 150. When the protrusion 157 is received within the groove 161, wall 150 can be positioned on the second body portion 120 at a distance from but substantially parallel to wall 165 so as to define the air outlet 145 between the walls 150, 160, and 165. Wall 150 can be fixed in place using various techniques, such as welding, adhesives, a snap-fit, etc.

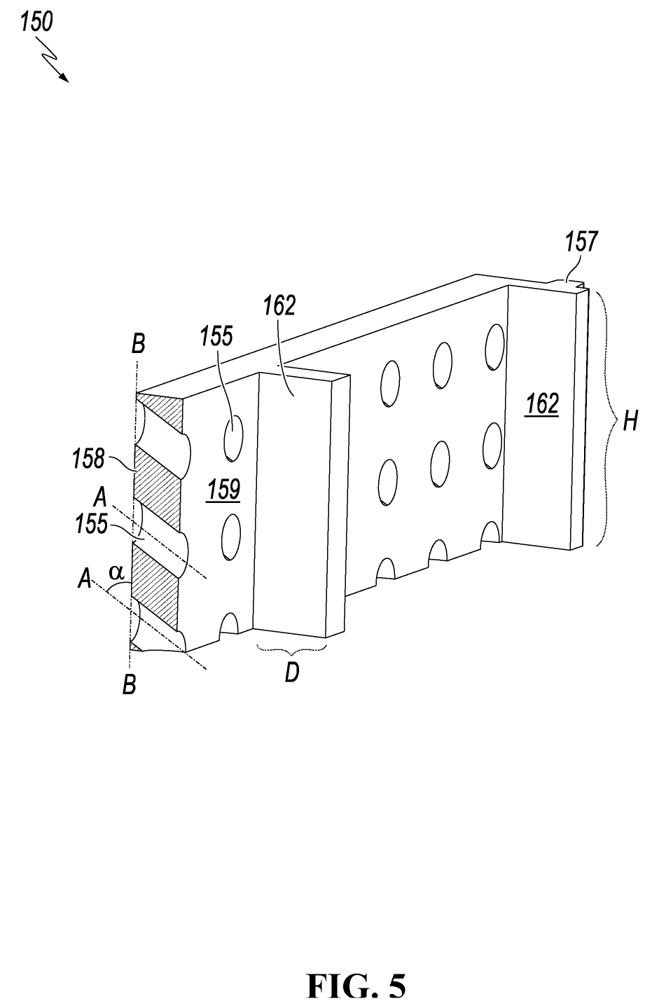

As shown in FIGS. 4A-5, the wall 150 can include a first surface 158 and a second surface 159 opposite the first surface. The wall 150 can include a plurality of openings 155 that can extend between the first surface 158 and the second surface 159. The openings 155 can be substantially circular-shaped on both the first surface 158 and the second surface 159, although other shapes of the openings 155 can be envisioned, such as oval-shaped openings or rectilinear-shaped openings. The openings 155 can be configured within the wall 150 in a regular or irregular pattern and need not be limited to the pattern of openings shown herein.

In some embodiments, the first surface 158 can be substantially planar and can form a contiguous planar surface with an edge of side walls 160. The second surface 159 can also be substantially planar and can include one or more ridges or protrusions 162 extending therefrom. The ridges 162 can function as a spacer, and/or can define distinct air outlet portions 145A-145C therebetween. As seen in FIG. 5, the ridges 162 can have a depth D that can define a width or depth of the air outlet 145. The wall 150 can be spaced from the wall 165 by the depth D of the ridge 162.

In some embodiments, the openings 155 can have a central longitudinal axis A that can be angled at an angle α relative to the first surface 158 and the second surface 159. For example, the openings 155 can extend at an angle α relative to a plane B containing the first surface 158. In some embodiments, the angle α can be between 15-30 degrees, 20-35, 25-40 degrees, 30-45 degrees, 35-50 degrees, 40-55 degrees, 45-60 degrees, 50-65 degrees, or 55-70 degrees.

A number of features of the attachment 100 can be adjusted to achieve desired airflow characteristics. For example, a size, a shape, an angle α, and a pattern of the openings 155 can be adjusted to achieve a desired third airflow FB through the wall 150. The depth D of the ridges 162 can be configured to enhance the velocity and/or pressure of the airflows FC and FD. The length of the walls 161 and 165 relative to a length of the wall 150 can be configured to ensure the airflow FD is directed along a longitudinal axis extending through the outlet 145.

FIG. 6 illustrates an exemplary embodiment of the airflow through the attachment 100. As shown, a primary airflow F can be received via the air inlet 135 in the appliance mating portion 125 from a hair care appliance to which it is coupled. The primary airflow F can flow through a lumen 108 in the nozzle 104 toward the outlet 145. The vanes 109 can be configured to guide the airflow F over the hemi-cylindrical region 121 of the second body portion 120 toward an opening 144 configured within the airflow pathway.

A secondary airflow FA can be drawn into the air inlets 140 from the ambient environment in which the attachment 100 is in use. The secondary airflow FA can flow between the nozzle 104 and the outer-most wall toward an opening 143 adjacent to opening 144. The openings 143 and 144 can be positioned adjacent to one another so as to allow the primary airflow F and the secondary airflow FA to be merged together into a combined airflow FC. In some embodiments, the openings 143 and 144 can be longitudinally offset or staggered relative to one another and the primary airflow F and the secondary airflow FA can be merged together into a combined airflow FC prior to passing adjacent to the wall 150. The combined airflow FC can pass between the walls 150, 160, and 165 of the second body portion 120 toward the air outlet 145. The ridges 162 can define separate outlet portions 145A-145C of the air outlet 145 and can divide the combined airflow FC into separate airflow portions.

As the combined airflow FC flows between walls 150 and 165, a suction force is created at the openings 155. The suction force is configured to draw a third airflow FB into the openings 155 configured in the wall 150 from the ambient environment. The suction force causes the third airflow FB to be drawn through the openings 155 and to be combined with the combined airflow FC exiting the openings 143, 144 to produce a resultant airflow FD exiting the outlet 145. The ridges 162 can further divide the resultant airflow FD into separate airflow portions. The resultant airflow FD can be directed through the outlet 145 in a direction that is substantially transverse to the direction of the airflow F that is received via the air inlet 135.

The attachment 100 provide a number of advantageous effects on the various airflows. For example, the tapered, distal end of the nozzle 104 (e.g., adjacent to the vanes 109) can cause the airflow F to undergo a Venturi effect, such that the pressure of the airflow F is reduced and the velocity of the airflow increases. The airflow F received via the air inlet 135 can have substantially high static pressure and lower velocity compared to the combined airflow FC and the resultant airflow FD. The tapered interface between the distal end of the nozzle 104 and the hemi-cylindrical portion 121 can create the Venturi effect and can act to reduce the volume through which the airflow F passes such that the combined airflow FC exiting the opening 144 has a lower static pressure and higher velocity than the airflow F received via the air inlet 135. In this way, the combined airflow FC has a substantially higher velocity and lower static pressure to create a suction force adjacent to the wall 150 to draw the third airflow FB through the openings 155 and into the combined airflow FC. The resultant airflow FD produced as a result of drawing the third airflow FB into the combined airflow FC maintains the high velocity, low static pressure characteristics as it flows through air outlet 145.

The configuration of the walls 150, 160 and 165 defining the air outlet 145 are advantageously configured to direct the resultant airflow FD along a greater portion of a user’s hair. The resultant airflow FD is directed at high velocity through the air outlet 145 in a direction that is aligned with a length of the user’s hair such that the airflow FD can flow along the full length of the user’s hair instead of being directed at a single location along the length of the user’s hair. The suction force created as a result of the combined airflow FC allows the third airflow FB to advantageously draw the user’s hair toward the wall 150 for more complete styling of a given amount of hair. For example, the third airflow FB can pull or draw individual hairs, or flyaway hairs, to be drawn toward the wall 150 for drying and styling with the bulk of the user’s hair already being dried or styled via the airflow FD. In this way, the attachment 100 enhances the user’s styling experience and ensures that individual flyaway hairs are styled at the same time and under the same conditions as the bulk of the hair being dried or styled via the airflow FD.

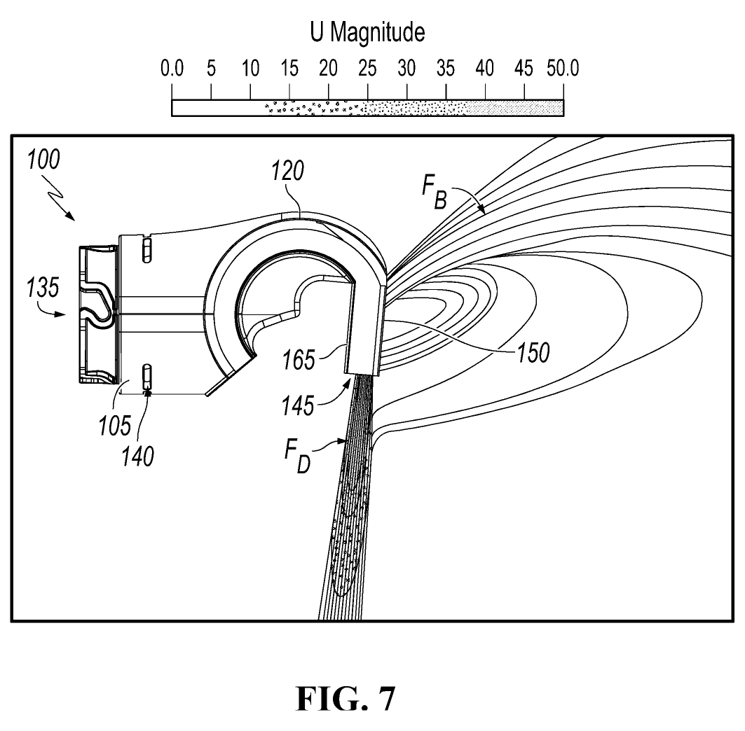

Computational fluid dynamic (CFD) data of the fluid flow provided by the attachment 100 is shown in FIGS. 7-9 and illustrate the advantageous benefits described herein for drying and styling hair. For example, as shown in FIG. 7, velocity data (in m/s) is shown for the resultant airflow FD exiting the air outlet 145 and the third airflow FB that is drawn toward the wall 150. As shown, the resultant airflow FD exits the outlet 145 between about 15 and 40 m/s. The resultant airflow FD exits the outlet 145 in a substantially downward direction that is aligned with the longitudinal axis extending through the outlet 145 and parallel to the orientation of the walls 150 and 165. The linear downward direction of the resultant airflow FD illustrates the benefit of orienting the airflow along a greater length of the user’s hair compared to attachments that provide a more diffuse airflow direction and/or pattern.

The third airflow FB is drawn or sucked toward the wall 150 between 0.0 and 15 m/s. As shown, the third airflow FB is distributed substantially uniformly across the entire height H of the wall 150 and the associated eddy currents of the third airflow FB spread vertically in front of the attachment 100 to provide a greater suction area for engaging hair during styling. Advantageously, this creates a larger suction zone in which a user can more readily engage hair with the attachment 100 or where individual flyaway hairs are more readily drawn toward the attachment 100 and into the resultant airflow FD for an easier, more efficient styling experience.

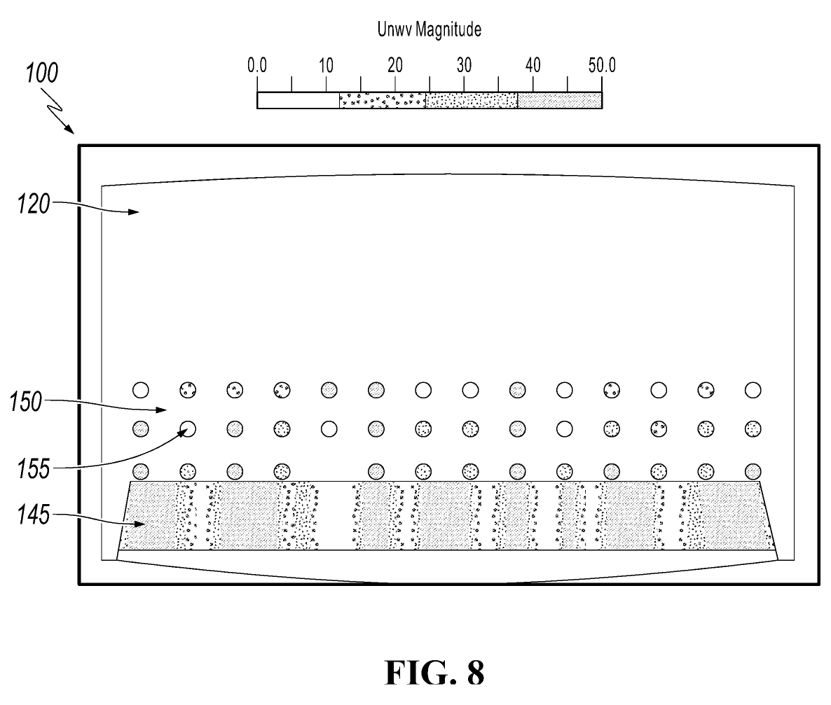

A front view of the second body portion 120 and the wall 150 is shown in FIG. 8 and illustrates the velocity of airflow over the second body and into the openings 155, and the resultant airflow FD exiting the outlet 145. The airflow adjacent to the second body portion 120 has a velocity between 0 and 5 m/s. The velocity increases as the third airflow FB enters the openings 155. The resultant airflow FD exiting the outlet 145 has a velocity between 20 and 50 m/s.

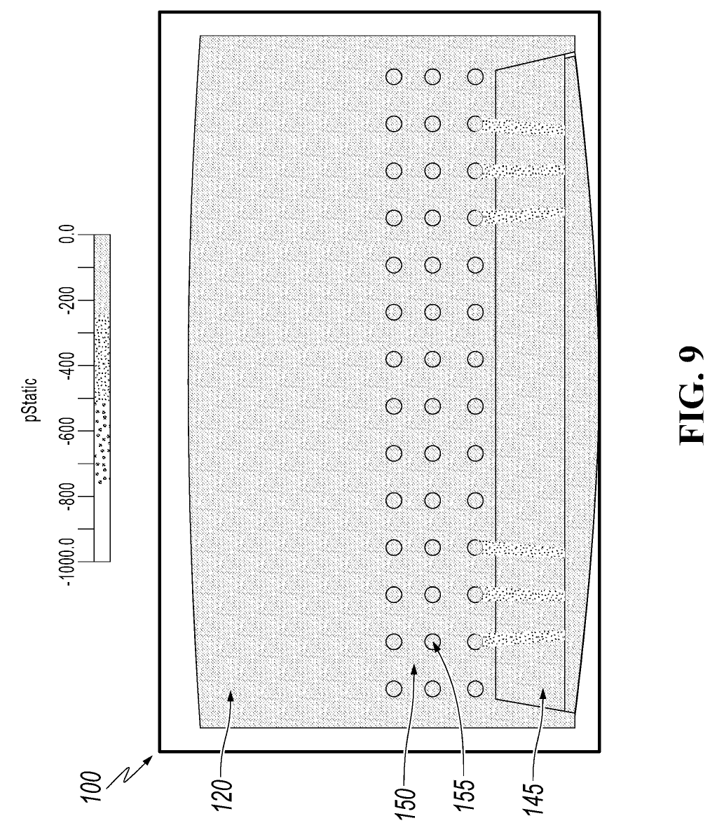

FIG. 9 is another front view of the second body portion 120 and the wall 150 and illustrates the static pressure of the airflow over the second body and into the openings 155, and the resultant airflow FD exiting the outlet 145. The static pressure of the airflow is nearly 0 adjacent to the second body portion 120 and at the openings 155. The static pressure of the resultant airflow FD exiting the outlet 145 has a static pressure between 0 and 15 Pa.

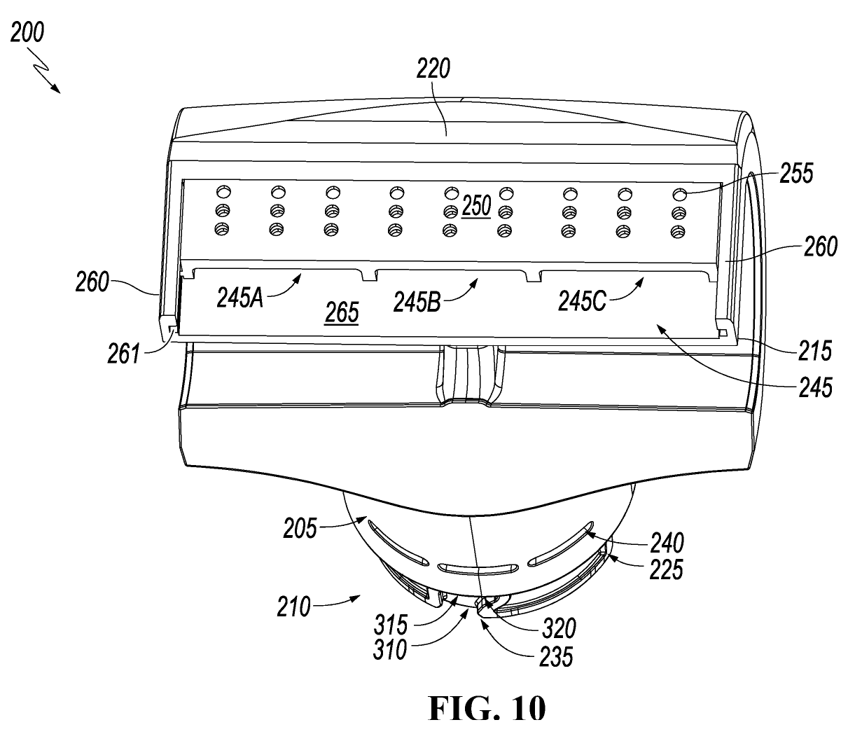

FIGS. 10-16 illustrate another exemplary embodiment of an attachment 200 in the form of a polishing attachment, however a person skilled in the art will appreciate that the features shown in the figures can be utilized in various other types of attachments, such as straighteners, or curlers. The attachment 200 is similar to the attachment 100 except where noted otherwise herein. The attachment 200 has a substantially “T-shape” and includes a substantially cylindrical-shaped proximal end 210 and a substantially hemi-cylindrically-shaped distal end 215 that is opposite the proximal end 210. A first body portion 205 can have a substantially cylindrical shape at the proximal end 210 and a second body portion 220 can have a substantially hemi-cylindrically-shape or C-shape at the distal end 215. The second body portion 220 can be oriented transversely to the first body portion 205. The first and second body portions 205, 220 together can define an airflow path for receiving a primary airflow F from a hair care appliance and delivering air to an outlet 245 at the distal end 215. As discussed further below, the second body portion 220 includes a porous surface through which a suction force is created to draw hair against the surface for smoothing and polishing the hair. As further discussed below, the first and second body portions 205, 220 include a second airflow FA therethrough for receiving secondary air, which combines with the primary airflow F and is delivered to the outlet 245.

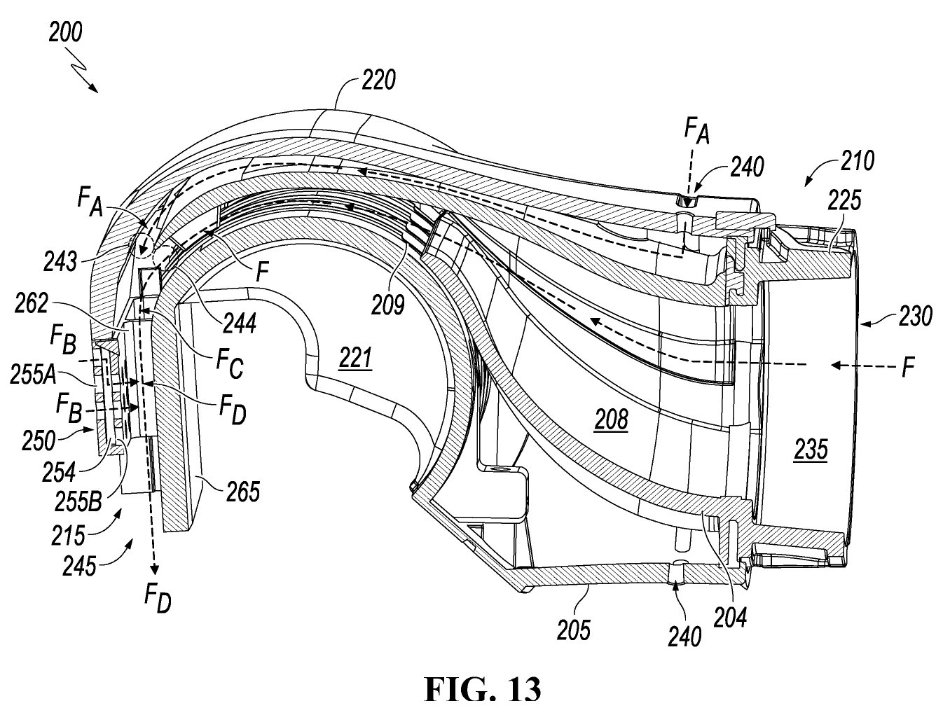

The first body portion 205 of the attachment 200 can have a variety of configurations, but in general it is configured to mate to a hair care appliance, and can define an airflow pathway therein for receiving airflow F from the hair care appliance and for delivering it to the hemi-cylindrically-shaped or C-shaped second body portion 220. As shown in FIGS. 10 and 13, the proximal end 210 includes an appliance mating mechanism 225 configured to mate the attachment 200 with a hair care appliance, such as a hair dryer. The appliance mating mechanism 225 can utilize various mating techniques, such as a twist-lock, magnets, a pressure-fit, or any other mating technique to facilitate attachment to a hair care appliance. The appliance mating mechanism 225 can include an opening 230 at the proximal end 210 defining a first air inlet 235, as shown in FIG. 13. The first air inlet 235 can receive air from the hair care appliance when the attachment 200 is coupled to the hair care appliance via the appliance mating mechanism 225. The air inlet 235 can be fluidically coupled to a nozzle 204 as shown in FIG. 13 positioned within a cavity between the first body portion 205 and the second body portion 220. The nozzle 204 can extend from the proximal end 210 and into the second body portion 220 toward the distal end 215, and it can guide an airflow received from the hair care appliance toward an air outlet 245 at the distal end 215 of the attachment 200. In some embodiments, the second body portion 220 can include vanes 209 downstream of the nozzle 204 to aid in guiding the airflow. Further, in some embodiments, the vanes 209 can positioned in between or extend from portions of a heat-retention element, such as a thermally conductive metal plate positioned in the first body portion 205 or the second body portion 220. In some embodiments, the vanes 209 can additionally or alternatively be configured in the first body portion 205, such as on an inner surface of the nozzle 204 adjacent to the second body portion 220.

As further shown in FIG. 13, the nozzle can 204 can be spaced from an outer-most wall of the attachment 200 to define a primary airflow F within the attachment. The first body portion 205 can include one or more second air inlets 240 provided thereon and positioned at various locations there around. The air inlets 240 can extend into a secondary airflow FA and can be fluidically coupled with the primary airflow path such that a combined airflow FC is delivered toward the air outlet 245 at the distal end 215. In some embodiments, the air inlets 240 can be slot shaped, as shown. In some embodiments, the air inlets 240 can have other shapes besides slots, such as circles, ovals, or the like. In some embodiments, the configuration of the air inlets 240 in the first body portion 205 can be configured such that the airflow FA can cool the outer surfaces of the first body portion 205 and the second body portion 220.

Further details on the cylindrically-shaped configuration of the first body portion 205 and the hemi-cylindrically-shaped configuration of the second body portion 220 can be found in U.S. Patent Appl. No. 18/174,769 filed on Feb. 27, 2023, which is hereby incorporated by reference in its entirety.

As indicated above, the second body portion 220 is substantially hemi-cylindrically-shaped or C-shaped and is configured to receive air from the first body portion 205. In general, the second body portion 220 includes walls 250 and 265 that are spaced a distance apart from one another to define the airflow path therein. The walls 250 and 265 can extend from a first curved portion of the hemi-cylindrically-shaped second body portion 220 and can then become planar along a second planar portion extending toward the outlet 245.

As shown in FIGS. 10 and 13, the second planar portion includes two planar walls 250, 265 that are spaced a distance apart from one another. A side wall 260 extends between the two planar walls 250, 265 to form an enclosed area between the walls 250, 265. The walls 250, 260, and 265 together define the air outlet 245 at the distal end 215. As further shown, wall 250 can be porous with multiple openings therein configured to draw a third airflow FB toward the wall 250 as shown in FIG. 13 and into combination with the combined airflow FC created by the combination of the primary airflow F received via the air inlet 235 and the secondary airflow FA received via the air inlets 240. Once the third airflow FB is combined with the combined airflow FC, a resultant airflow FD passes between the walls 250 and 265 of the air outlet 245. In some embodiments, wall 250 can terminate a distance upstream of the air outlet 245, and thus walls 260 and 265 can extend past wall 250, such that a length of walls 260, 265 is greater than a length of wall 250.

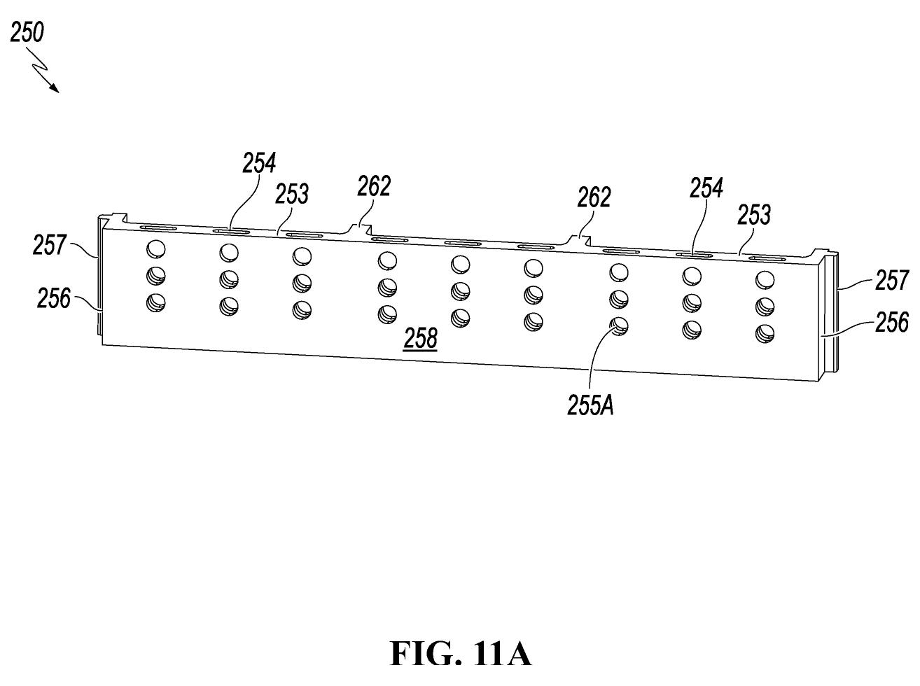

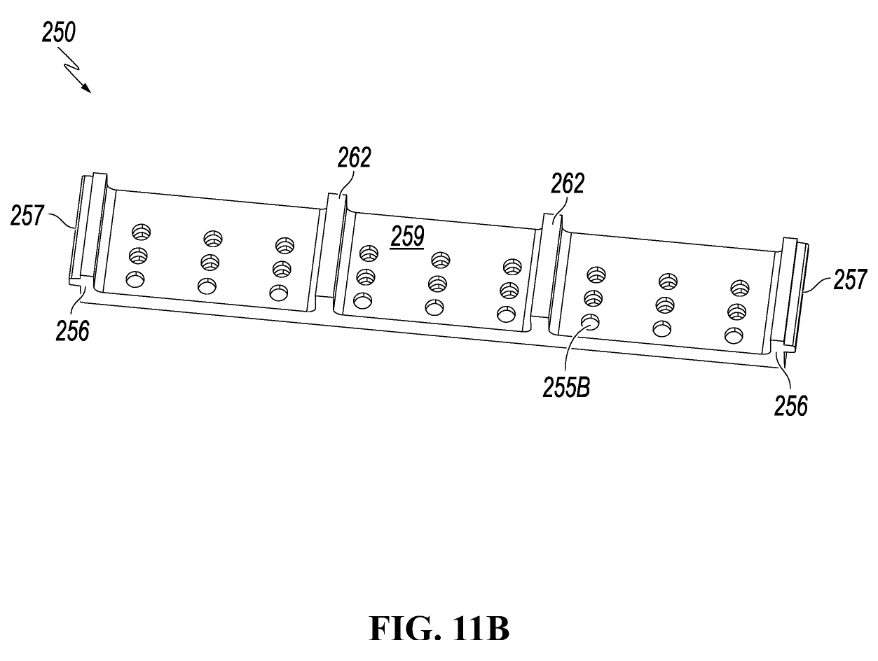

In some embodiments, wall 250 can be coupled to the side walls 260 via an attachment mechanism, such as a snap-fit, friction-fit, or the like. As shown in FIG. 10, the attachment mechanism includes a groove 261 extending along the side walls 260. The groove 261 can be configured to receive a protrusion 257, shown in FIGS. 11A -12B, extending along the side walls 256 that protrude from the wall 250. When the protrusion 257 is received within the groove 261, wall 250 can be positioned on the second body portion 220 at a distance from but substantially parallel to wall 265 so as to define the air outlet 245 between the walls 250, 260, and 265. Wall 250 can be fixed in place using various techniques, such as welding, adhesives, a snap-fit, etc.

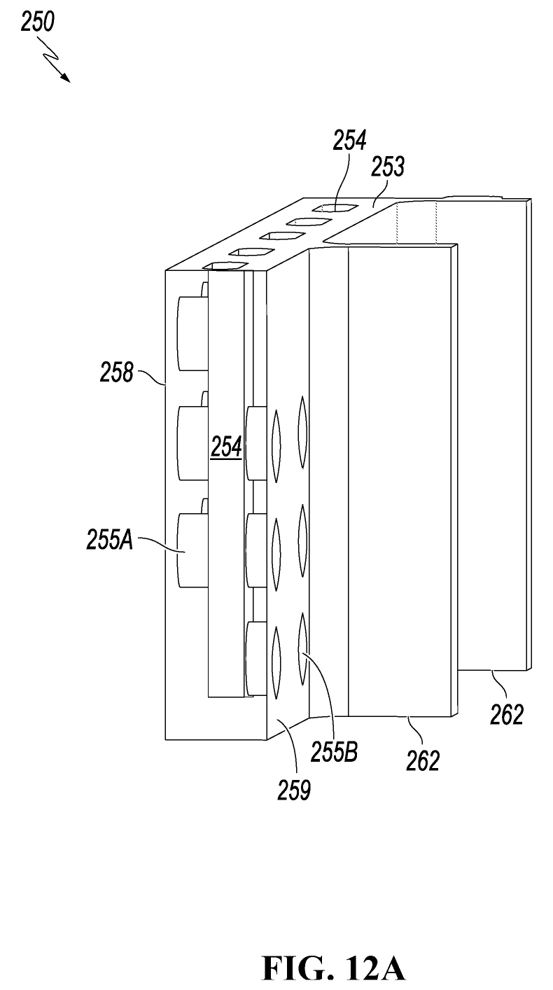

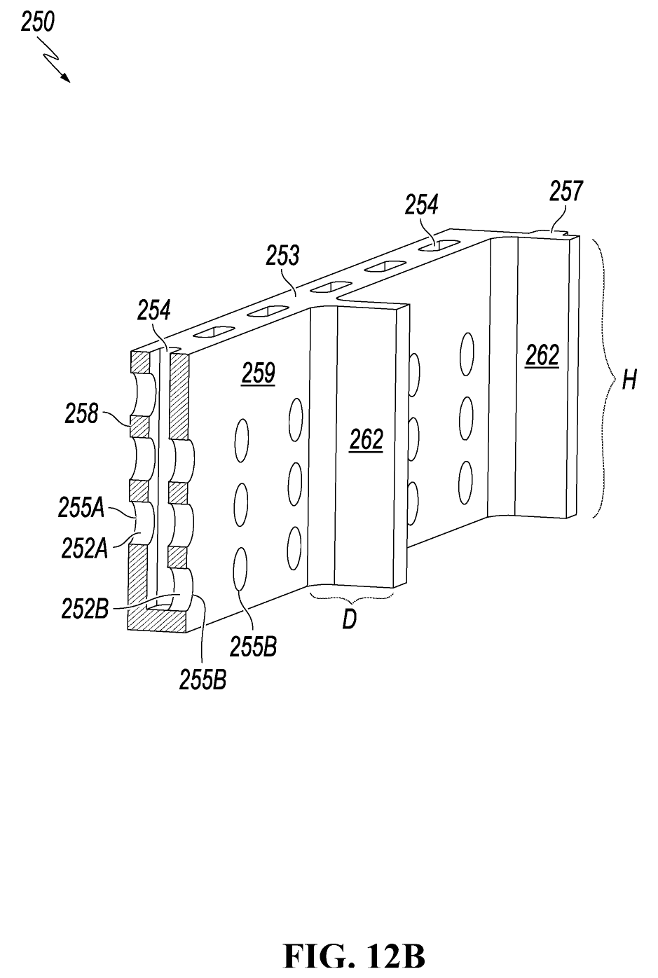

As shown in FIGS. 11A-12B, the wall 250 can include a first surface 258 in which a first plurality of openings 255A are positioned and a second surface 259 in which a second plurality of openings 255B are positioned. A plurality of channels 254 can extend from a third surface 253 into the wall 250 so as to fluidically couple the openings 255A and 255B on opposing surfaces of the wall 250 as shown in FIG. 12A. As shown in FIG. 12B, the channel 254 can be fluidically coupled to the openings 255 (e.g., 255A and 255B) via channels 252. For example, as shown in FIG. 12B, the opening 255A can be an opening in the first surface 258 of channel 252A, which is fluidically coupled to channel 254. The channel 254 can be fluidically coupled to the channel 252B and the opening 255B in the second surface 259 of the wall 250. The channels 254 can be sealed with the second body portion 220 when the wall 250 is positioned therein as shown in FIG. 10.

In some embodiments, the channels 252 can be oriented perpendicular relative to the surfaces 258 and/or 259. In some embodiments, the channels 252 can be oriented at an angle relative to the surfaces 258 and/or 259. In some embodiments, the location of channels 252 on the surfaces 258, 259 relative the longitudinal axis extending through the channel 254 can vary along the height H of the wall 250 as shown in FIGS. 11A-12B. In some embodiments, the location of channels 252 on the surfaces 258, 259 relative to longitudinal axis extending through the channel 254 can be the same along the height H of the wall 250. A variety of locations and distribution patterns of the openings 255 and the channels 252 extending across the wall 250 and along its height H can be envisioned and need not be limited to the locations and distribution patterns shown herein.

A number of features of the attachment 200 can be adjusted to achieve desired airflow characteristics. For example, a size, a shape, an angle, and a pattern of the openings 255 and channels 252 can be adjusted to achieve a desired third airflow FB through the wall 250. The depth D of the ridges 262 can be configured to enhance the velocity and/or pressure of the airflows FC and FD. The length of the walls 261 and 265 relative to a length of the wall 250 can be configured to ensure the airflow FD is directed along a longitudinal axis extending through the outlet 245.

In FIG. 13, an exemplary embodiment of the airflow through the attachment 200 is illustrated. The airflow through the attachment 200 is similar to that of the airflow through the attachment 100, except where noted otherwise. As shown, a primary airflow F can be received via the air inlet 235 in the appliance mating portion 225 from a hair care appliance to which it is coupled. The primary airflow F can flow through a lumen 208 in the nozzle 204 toward the outlet 245. The vanes 209 can be configured to guide the airflow F over the hemi-cylindrical region 221 of the second body portion 220 toward an opening 244 configured within the airflow pathway.

A secondary airflow FA can be drawn into the air inlet 240 from the ambient environment in which the attachment 200 is in use. The secondary airflow FA can flow between the nozzle 204 and the outer-most wall toward the opening 243 adjacent to opening 244. The openings 243 and 244 can be positioned adjacent to one another so as to allow the primary airflow F and the secondary airflow FA to be merged together into a combined airflow FC. In some embodiments, the openings 243 and 244 can be longitudinally offset or staggered relative to one another and the primary airflow F and the secondary airflow FA can be merged together into a combined airflow FC prior to passing adjacent to the wall 250. The combined airflow FC can pass between the walls 250, 260, and 265 of the second body portion 220 toward the air outlet 245. The ridges 262 can define separate outlet portions 245A-245C of the air outlet 245 and can divide the combined airflow FC into separate airflow portions.

As the combined airflow FC flows between walls 250 and 265, a suction force is created at the openings 255 (e.g., opening 255A). The suction force is configured to draw a third airflow FB into the opening 255A configured in the wall 250 from the ambient environment. The suction force causes the third airflow FB to be drawn through the opening 255A, into the channels 252A, 254, 252B, and the opening 255B and into combination with the combined airflow FC exiting the openings 243, 244 to produce a resultant airflow FD exiting the outlet 245. The ridges 262 can further divide the resultant airflow FD into separate airflow portions. The resultant airflow FD can be directed through the outlet 245 in a direction that is substantially transverse to the direction of the airflow F that is received via the air inlet 235.

The attachment 200 provide a number of advantageous effects on the various airflows. For example, the tapered, distal end of the nozzle 204 (e.g., adjacent to the vanes 209) can cause the airflow F to undergo a Venturi effect, such that the pressure of the airflow F is reduced and the velocity of the airflow increases. The airflow F received via the air inlet 235 have substantially high static pressure and lower velocity compared to the combined airflow FC and the resultant airflow FD. The tapered interface between the distal end of the nozzle 204 and the hemi-cylindrical portion 221 can create the Venturi effect and can act to reduce the volume through which the airflow F passes such that the combined airflow FC exiting the opening 244 has a lower static pressure and higher velocity than the airflow F received via the air inlet 235. In this way, the combined airflow FC has a substantially high velocity and lower static pressure to create a suction force adjacent to the wall 250 to draw the third airflow FB through the openings 255 and into the combined airflow FC. The resultant airflow FD produced as a result of drawing the third airflow FB into the combined airflow FC maintains the high velocity, low static pressure characteristics as it flows through air outlet 245.

The walls 250, 260 and 265 defining the air outlet 245 are advantageously configured to direct the resultant airflow FD along a greater portion of a user’s hair. The resultant airflow FD is directed at high velocity through the air outlet 245 in a direction that is aligned with a length of the user’s hair such that the airflow FD can flow along the full length of the user’s hair instead of being directed at a single location along the length of the user’s hair. The suction force created as a result of the combined airflow FC allows the third airflow FB to advantageously draw the user’s hair toward the wall 250 for more complete styling of a given amount of hair. For example, the third airflow FB can pull or draw individual hairs, or flyaway hairs, to be drawn toward the wall 250 for drying and styling with the bulk of the user’s hair already being dried or styled via the airflow FD. In this way, the attachment 200 enhances the user’s styling experience and ensures that individual flyaway hairs are styled at the same time and under the same conditions as the bulk of the hair being dried or styled via the airflow FD.

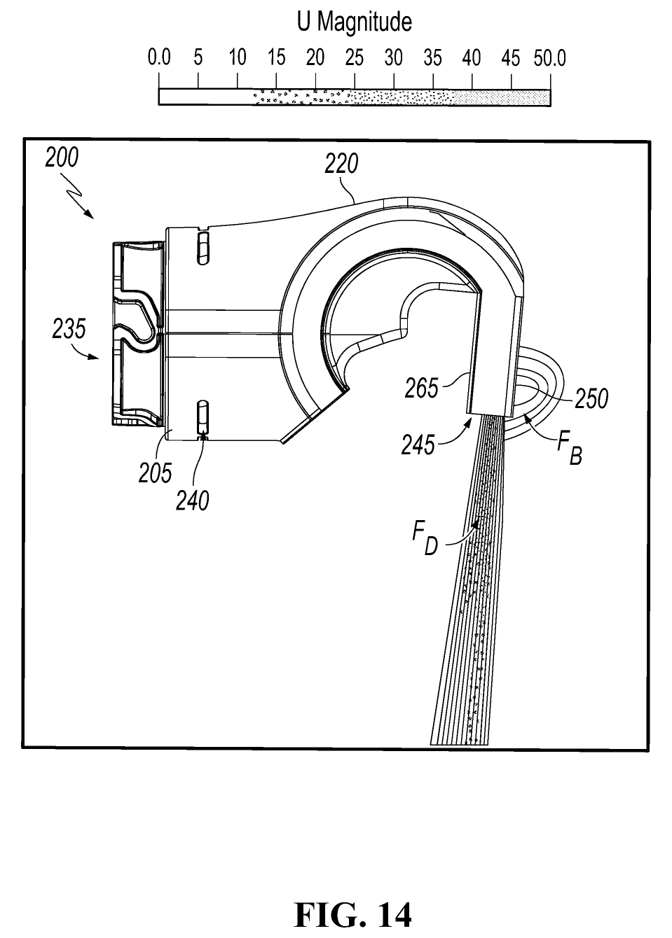

Computational fluid dynamic (CFD) data of the fluid flow provided by the attachment 200 is shown in FIGS. 14-16 and illustrate the advantageous benefits described herein for drying and styling hair. For example, as shown in FIG. 14, velocity data (in m/s) is shown for the resultant airflow FD exiting the air outlet 245 and the third airflow FB that is drawn toward the wall 250. As shown, the resultant airflow FD exits the outlet 245 between about 15 and 40 m/s. The resultant airflow FD exits the outlet 245 in a substantially downward direction that is aligned with the longitudinal axis extending through the outlet 245 and parallel to the orientation of the walls 250 and 265. The linear downward direction of the resultant airflow FD illustrates the benefit of orienting the airflow along a greater length of the user’s hair compared to attachments that provide a more diffuse airflow direction and/or pattern.

The third airflow FB is drawn or sucked toward the wall 250 between 0.0 and 7 m/s. As shown, the third airflow FB is concentrated at the location along the wall 250 where the openings 255A are positioned and the associated eddy currents of the third airflow FB are concentrated adjacent to the outlet 245 to provide a more defined suction area for engaging hair during styling. Advantageously, this creates a suction zone that a user can more readily identify to engage hair with the attachment 200 or where individual flyaway hairs are more readily drawn toward the attachment 200 and into the resultant airflow FD for an easier, more efficient styling experience.

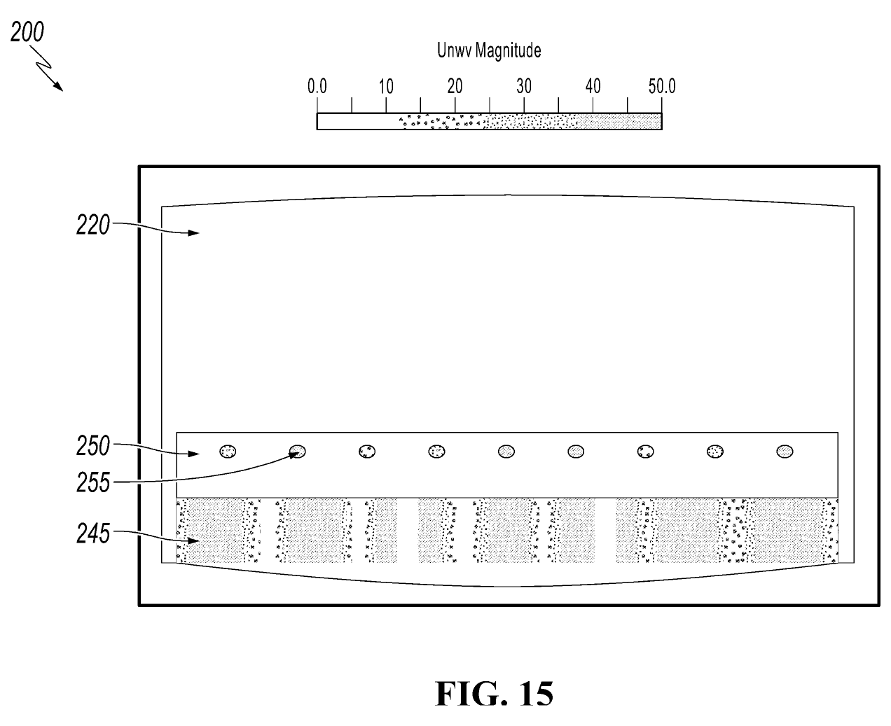

A front view of the second body portion 220 and the wall 250 is shown in FIG. 15 and illustrates the velocity of airflow over the second body and into the openings 255A, and the resultant airflow FD exiting the outlet 245. The airflow adjacent to the second body portion 220 has a velocity between 0 and 3 m/s. The velocity increases as the third airflow FB enters the openings 255. The resultant airflow FD exiting the outlet 245 has a velocity between 20 and 50 m/s.

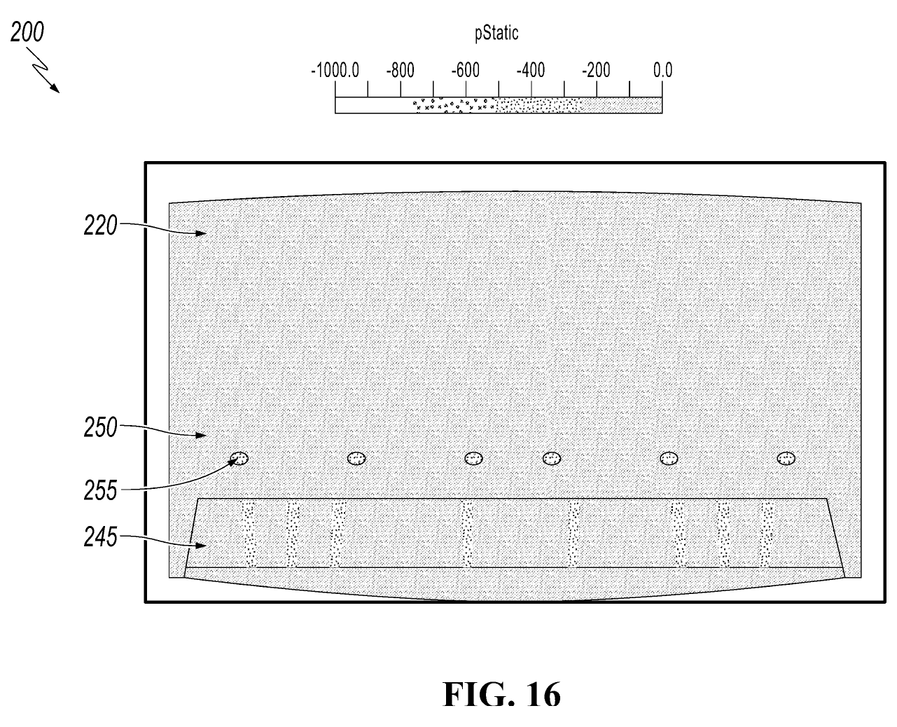

FIG. 16 is another front view of the second body portion 220 and the wall 250 and illustrates the static pressure of the airflow over the second body and into the openings 255, and the resultant airflow FD exiting the outlet 245. The static pressure of the airflow is nearly 0 adjacent to the second body portion 220 and at the openings 255. The static pressure of the resultant airflow FD exiting the outlet 245 has a static pressure between 0 and 10 Pa.

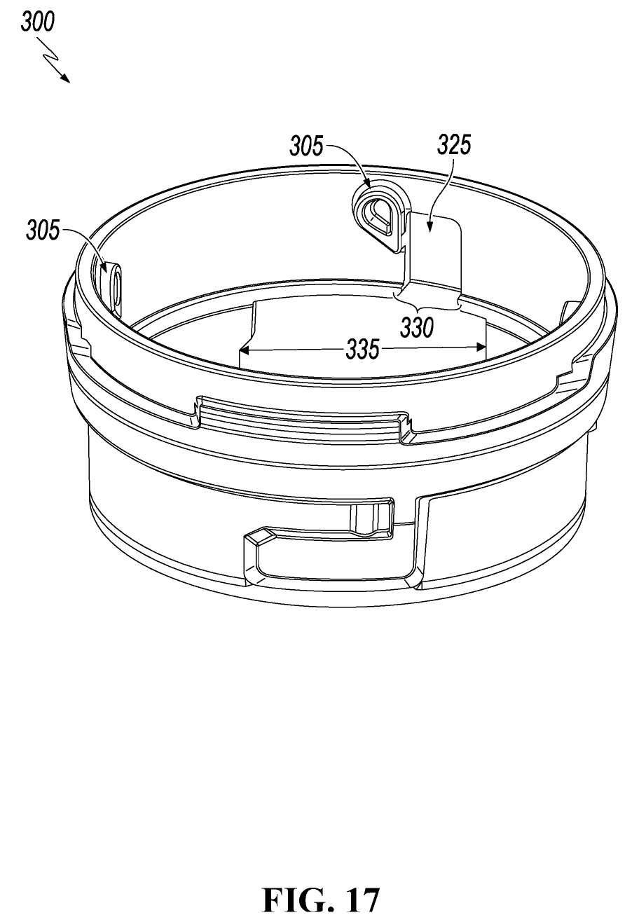

As indicated above, the attachment 100, 200 is configured to mate with a hair care appliance, and thus includes an appliance mating mechanism 125, 225 configured to couple to an attachment mating portion on the hair care appliance. In some embodiments, the appliance mating mechanism 125, 225 can be formed on exterior surfaces of the first body portion 120, 205 and the second body portion 120, 220. In some embodiments, the appliance mating mechanism 125, 225 can be formed within the nozzle 104, 204 as shown in FIGS. 1-3, 10, and 13. While the mating connection between the two components can vary, FIG. 17 illustrates one embodiment of an attachment mating portion 300 on a hair care appliance that is configured to receive and couple with the appliance mating mechanism 125, 225 of the attachment 100, 200 described herein. The illustrated attachment mating portion 300 includes one or more protrusions 305 on an inner surface of the attachment mating portion 300. The protrusions 305 can be received within the openings 310 of the slots 315 (shown on the appliance mating mechanism 125, 225 in FIGS. 1 and 10) and can travel to the receiving end 320 as the user couples the attachment 100, 200 onto the outlet end of the hair care appliance.

The attachment mating portion 300 can also include at least one recess 325 configured to receive a tab or protruding portion of an attachment actuator assembly of the hair care appliance. The attachment actuator assembly can be configured with a latch that is coupled to a spring force mechanism. The spring force mechanism can maintain the latch and the tab portion in a first position in which the tab or protruding portion is positioned within the recess 325 or a second position in which the latch is retracted away from the attachment mating portion 300 causing the tab or protruding portion to move out of the recess 325. Coupling the appliance mating mechanism 125, 225 with the attachment mating portion 300 can cause the spring force mechanism to move the tab portion into the first position without user manipulation of the latch. Uncoupling the appliance mating mechanism 125, 225 from the attachment mating portion 300 can require manual manipulation of the latch by a user to retract the latch and cause the tab portion to move out of the recess 325 allowing removal of the attachment 100, 200 from the hair care appliance. In some embodiments, the user may retract the latch to the second position, affix the appliance mating mechanism 125, 225 to the attachment mating portion 300, and release the latch causing the spring force mechanism to move the latch and tab into the first position.

The recess 325 can have a width 330 corresponding to a width of the tab or protruding portion of the attachment actuator assembly. As the appliance mating mechanism 125, 225 of the attachment 100, 200 is mated with attachment mating portion 300, the protrusions 305 can travel into the slots 315 on the appliance mating mechanism 125, 225. As explained in detail below, once travel of the protrusions 305 into the slots 315 is complete the spring force of the attachment actuator assembly can cause the latch of the attachment actuator assembly to travel toward the attachment mating portion 300 so that the tab portion of the attachment actuator assembly travels into the recession 325 locking the attachment in place to prevent rotation of the attachment 100, 200 on the hair care appliance. The attachment mating portion 300 can also include an opening 335 along the circumference of the bottom portion of the attachment mating portion 300. The opening 335 can receive the attachment actuator assembly therein.

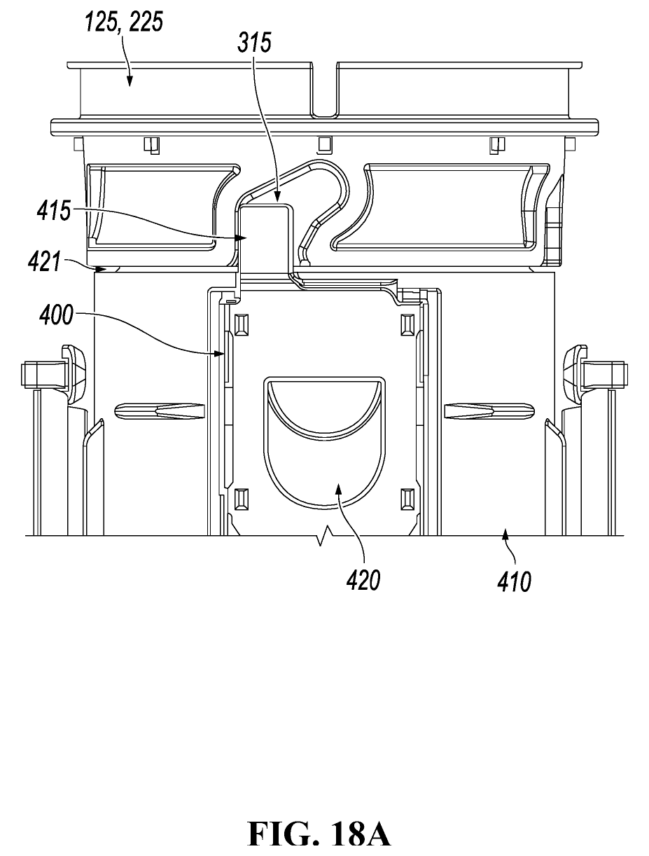

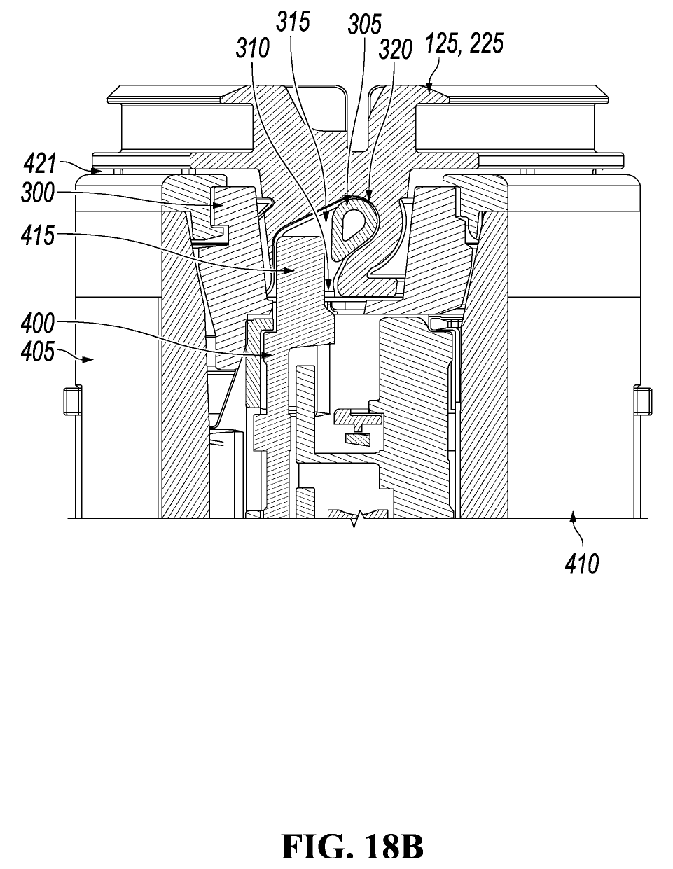

The attachment actuator assembly 400 of the hair care appliance is shown in more detail in FIGS. 18A and 18B, with the attachment actuator assembly 400 engaged with the appliance mating mechanism 125, 225 of the attachment 100, 200 according to embodiments described herein. Engagement between the appliance mating mechanism 125, and the attachment mating portion 400 can result from aligning the attachment mating portion 400 with the appliance mating mechanism 125, 225 (or vice versa) and urging the attachment mating portion 400 and the appliance mating mechanism 125, 225 together until the attachment actuator assembly 400 engages with the appliance mating mechanism 125, 225.

As shown in FIG. 18A, the attachment mating portion 300 and the body 405 of the hair care appliance 410 have been removed for illustration and engagement of the appliance mating mechanism 125, 225 with the attachment actuator assembly 400 can be viewed. The illustrated attachment actuator assembly 400 includes a latch 420 and a tab 415 coupled to or integrated within the latch 420. The attachment actuator assembly 400 can be a spring drive mechanism, or the like, configured to urge the latch 420 (and thus the tab 415) into engagement with the mating mechanism 125, 225.

As discussed above, the slots 315 of the appliance mating mechanism 125, 225 include an opening 310 at which the protrusions 305 and/or a tab 415 of the attachment mating portion 300 can be received when the attachment 100, 200 is coupled with the hair care appliance 410. When the protrusions 305 reach the receiving end 320, the tab 415 can travel toward the outlet end 421 of the hair care appliance 410 and to be positioned within the opening 310 and the slot 315. In this way, the tab 415 can fill a portion of the slot 315 such that the protrusion 305 is blocked from rotating away from or out of the receiving end 320. As a result, the attachment 100, 200 can be secured to the body 405 and rotation of the attachment 100, 200 relative to the body 405 is significantly reduced or eliminated.

Retracting the latch 420 can cause the tab 415 to travel out of the slot 315 and as the user removes the attachment 100, 200 from the body 405, the protrusions 305 can travel from the receiving end 320 to the opening 310 of the slots 315 to allow uncoupling the attachment 100, 200 from the body 405 of the hair care appliance 410.

FIG. 18B illustrates a cut-away view of the attachment actuator assembly 400 engaged with the appliance mating mechanism 125, 225. The cut-away view shows an internal perspective of the attachment actuator assembly 400 engaged with the appliance mating mechanism 125, 225, as well as one of the protrusions 305 engaged with the appliance mating mechanism 125, 225. The user has coupled the appliance mating mechanism 125, 225 with the attachment mating portion 300 such that the protrusion 305 has traveled into a receiving end 310 located at a terminal end of the slot 315. In the cut-away view illustrated in FIG. 18B, the additional protrusions 305 on the opposite side of the attachment mating portion 300 are not shown but it will be understood that the additional protrusions 305 on the opposite side of the attachment mating portion 300 are also engaged with the slots 315 present on the opposite side of the appliance mating mechanism 125, 225. Once the protrusions 305 are fully inserted into the slot 315, the spring force of the attachment actuator assembly 400 can cause the latch 420 to travel toward the outlet end 421 of the hair care appliance 410 causing the tab 415 to travel into the slot 315 to secure the attachment mating portion 300 of the hair care appliance 410 to the appliance mating mechanism 125, 225 of the attachment 100, 200. In some embodiments, the tab 415 can be received within the recess 325 of the attachment mating portion 300 and the protrusions 305 can be received within the openings 315 of the appliance mating mechanism 125, 225. The attachment 100, 200 is thus secured to the hair care appliance 410 by the engagement of the protrusions 305 of the attachment mating portion 300 within the receiving end 320 of the slots 315 of the appliance mating mechanism 125, 225. Additionally the protrusions 305 are secured within the slots 315 by the tab 415 of the attachment actuator assembly 400. The tab 415 can be positioned within the opening 310 of the slots 315 to prevent the protrusions 305 from coming out of the opening 310. As a result, the attachment 100, 200 can be attached to the hair care appliance 410 securely and rotation of the attachment 100, 200 relative to the body 405 of the hair care appliance 410 can be reduced or eliminated.

In use, the attachment 100, 200 can be used to polish, straighten, de-frizz, and improve shine, or otherwise style hair by coupling the attachment 100, 200 to a hair care appliance and engaging the user’s hair with the resultant airflow FD. The hair care appliance can generate air flow that is received at the air inlet 135,235 of the attachment 100,200 and directed through the outlet 145, 245. A user can hold the hair care appliance coupled with the attachment 100, 200 attached thereto in one hand and position the distal end 115, 215 of the attachment 100, 200 adjacent to their scalp at a location at which they wish to style their hair. With the hair care appliance 410 powered on such that heated air exits the outlet 145, 245 along the path of the resultant airflow FD, the user can draw the distal end 115, 215 of the attachment 100, 200 down or otherwise along the length of their hair. The high-velocity airflow FD exiting the outlet 145, 245 can also draw hair toward the wall 150, 250 via the third airflow FB. In this way, a larger amount of the user’s hair can be brough into contact with the wall 150, 250 and the outlet 145, 245 to polish, straighten, de-frizz and increase shine of their hair. The user can repeat this process at other desired locations where frizzy, dull, or fly-away hairs may be present.

The improved hair polishing attachment 100, 200 described herein and configured for use with a hair care appliance produces a number of advantages. For example, the configuration of the air flow paths F, FA, and FC and the outlets 145, 245 can generate a high-velocity, low-pressure airflow configured to generate a suction force through wall 150, 250 so that the third airflow FB can draw individual or flyaway hairs toward the attachment 100, 200. As a result of these features, the attachment 100, 200 described herein can allow users to engage larger amounts of hair more efficiently and can reduce the time to polish, straighten, de-frizz or shine hair compared to existing hair care appliance attachments.

As used herein, the term “proximal” can define a location of an element that is upstream of an air flow path and thus closer in proximity to the outlet of a hair care appliance to which the attachment can be coupled or closer to an air inlet of the attachment. The term “proximal” can also refer to a location that is closer to a handle of the hair care appliance at which the user may grasp the hair care appliance. The term “distal” can define a location of an element that is downstream of the air flow path and thus further away from the outlet of the hair care appliance. The term “distal” can also refer to a location that is farther away from the handle of the hair care appliance. The term “distal” can refer to a location that is closer to an outlet of the attachment at which the air flow path exits the attachment. A distal location will be opposite a proximal location and vice versa.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. An attachment for a hair care appliance, comprising:
an inlet, an outlet, an airflow path extending therebetween, and a surface adjacent to the airflow path having a plurality of openings, wherein the attachment is configured such that air flowing along the airflow path creates a suction force at the surface to draw ambient air through the plurality of openings that draw hair towards the surface.

2. The attachment of claim 1, wherein the surface is planar.

3. The attachment of claim 1, wherein the plurality of openings extend through the surface at an angle relative to a longitudinal axis of the airflow path exiting the outlet.

4. The attachment of claim 1, wherein the plurality of openings comprise a first plurality of inlet channels and a second plurality of inlet channels, the first and second plurality of inlet channels fluidically oriented transversely to a longitudinal axis of the airflow path exiting the outlet.

5. The attachment of claim 4, wherein the first and second plurality of inlet channels are fluidically coupled to one another via a conduit oriented parallel to the longitudinal axis of the airflow path exiting the outlet.

6. The attachment of claim 4, wherein the first and second plurality of inlet channels are offset from one another relative to the longitudinal axis of the airflow path exiting the outlet.

7. The attachment of claim 1, wherein the surface is positioned transversely to an axis of the airflow path entering the inlet.

8. The attachment of claim 1, wherein the surface comprises a first surface spaced apart from a second surface such that the airflow path flows between the first surface and the second surface prior to exiting the outlet.

9. The attachment of claim 8, wherein the first surface and the second surface are planar surfaces.

10. The attachment of claim 8, wherein a distal end of the second surface extends beyond a distal end of the first surface relative to the longitudinal axis of the airflow path exiting the outlet.

11. The attachment of claim 1, further comprising a nozzle having a substantially cylindrical first portion defining the inlet therein, the nozzle being configured to mate to a hair care appliance.

12. The attachment of claim 11, wherein the attachment includes a first cover and a second cover coupled to the first cover and enclosing the nozzle therein, at least one of the first cover and the second cover including at least one second inlet open to an ambient environment surrounding the attachment.

13. The attachment of claim 1, wherein the attachment is configured such that suction force is generated based on a static pressure of the airflow flowing along the airflow path adjacent to the surface being lower than a static pressure of an airflow received at the inlet.

14. A hair care appliance, comprising:
an air inlet, an air outlet, a lumen extending between the air inlet and the air outlet, a porous surface extending adjacent to at least a portion of the lumen, and a fan assembly configured to generate an airflow path through the lumen between the inlet and the outlet such that ambient air is drawn into the lumen through the porous surface to cause hair adjacent to the surface to be drawn in against the surface.

15. The hair care appliance of claim 14, wherein the porous surface includes a plurality of pores oriented at an angle relative to a longitudinal axis of the airflow path exiting the air outlet.

16. The hair care appliance of claim 14, wherein the porous surface includes a first plurality of pores coupled to a second plurality of pores via a common conduit extending within the porous surface parallel to a longitudinal axis of the airflow path exiting the air outlet.

17. The hair care appliance of claim 16, wherein the first plurality of pores are offset from the second plurality of pores relative to the longitudinal axis of the airflow path exiting the air outlet.

18. The hare care appliance of claim 14, wherein the porous surface is spaced apart from a second surface opposite the porous surface and defining the lumen therebetween.

19. The hair care appliance of claim 18, further comprising at least one ridge extending between the porous surface and second surface and defining a height of the air outlet.

20. The hair care appliance of claim 18, further comprising opposing end walls extending from the second wall toward the first wall, the opposing end walls including a groove extending longitudinally there along and configured to receive a protrusion extending longitudinally along opposing ends of the first wall.

21. The hair care appliance of claim 14, wherein the lumen comprises at least two lumen portions dividing the airflow path through the lumen.

22. The hair care appliance of claim 14, wherein the fan assembly is configured to generate a static pressure in the airflow path through the lumen that is higher than a static pressure of an airflow path entering the air inlet.
